(19) United States
(12) Patent Application Publication
(10) Pub. No.: US 2009/0180183 A1
(43) Pub. Date: Jul. 16, 2009

(54) Zoom lens system

(75) Inventor: Min Heu, Changwon-City (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-City (KR)

(21) Appl. No.: 12/316,227

(22) Filed: Dec. 10, 2008

(30) Foreign Application Priority Data
Jan. 11, 2008 (KR) 10-2008-0003514

(51) Int. Cl. G02B 27/64; G02B 15/14

(52) U.S. Cl. 359/554; 359/683

(57) ABSTRACT

A zoom lens system is provided that includes a first lens group having positive refractive power; a second lens group having negative refractive power; and at least one lens group disposed between the second lens group and an image side. The first, second, and the at least one lens group are sequentially arranged from an object side to the image side. During a magnification change from a wide-angle position to a telephoto position, lens groups including at least the second lens group are moved, and the first lens group includes a first lens having negative refractive power, a reflector bending the optical axis by 90°, and a rear lens group including at least one lens having positive refractive power and disposed after the reflector. The whole rear lens group or a portion of the rear lens group is moved to correct an image shake phenomenon caused by vibration.

### CROSS-REFERENCE TO RELATED PATENT APPLICATION

This application claims the benefit of Korean Patent Application No. 10-2008-0003514, filed on Jan. 11, 2008 in the Korean Intellectual Property Office, the entire contents of which is incorporated herein by reference.

### BACKGROUND OF THE INVENTION

1. Field of the Invention

The present invention relates to a zoom lens system. More particularly, the present invention relates to a zoom lens system which corrects an image shaking phenomenon caused from vibrations resulting from a user's hand shaking during photographing operation.

2. Description of the Related Art

In recent times, as an imaging device, such as a charge-coupled device (CCD) and/or a complementary metal-oxide semiconductor (CMOS), continue to be further miniaturized, the demand for compact and slim electronic devices that utilize such an imaging device is increasing. Slim and compact cameras are classified as a slider type, in which a zoom lens protrudes out of the camera body during use and is kept inside the camera body when not used, and an inner zoom type, in which a reflector such as a prism is used so that a lens system has a reduced thickness.

However, the slider type apparatus can be miniaturized by reducing the entire length of a barrel when the camera is powered off. Thus, it is difficult to embody the slider type, which is much slimmer than a conventional camera, by using a high-magnification zoom lens. Moreover, it takes a long time for the slider type apparatus to change from an initial position to an operating position when the camera is powered on. In addition, a lens group that is closest to an object side protrudes out of the camera in such an arrangement. As a result, the slider type is more sensitive to impact and environmental effects, such as water. Accordingly, there is a need for an optical system of an inner zoom lens arrangement that changes an optical path. The thickness of such a refraction type optical system that includes a prism can be reduced by changing the optical path of light in the middle of the optical system utilizing the prism by 90°. Accordingly, the demand for shake correction in a compact camera arrangement is further increased.

Conventionally, the movement of an image surface, which is caused by shaking occurring during photographing operations, is corrected using a fifth lens group. However, since the fifth lens group has a low imaging magnification, the fifth lens group needs to be moved by a significant amount in order to correct for the shaking phenomenon. Thus, the resolving power of an imaging device can be reduced. Accordingly, in order to maintain the resolution of an optical system, the configuration of the lens groups becomes complicated and the number of required lenses is increased.

### SUMMARY OF THE INVENTION

The present invention provides a compact zoom lens system which corrects an image shake phenomenon caused by the shaking of a user's hand during a photographing operation.

According to an embodiment of the present invention, a zoom lens system is provided that includes: a first lens group having positive refractive power; a second lens group having negative refractive power; and at least one lens group disposed between the second lens group and an image side, wherein the first, second, and the at least one lens group are sequentially arranged from an object side to the image side, during a magnification change from a wide-angle position to a telephoto position, lens groups including at least the second lens group are moved with respect to an optical axis, and the first lens group comprises a first lens having negative refractive power, a reflector bending the optical axis by 90°, and a rear lens group comprising at least one lens having positive refractive power and disposed after the reflector, and the whole rear lens group or a portion of the rear lens group is moved in a direction perpendicular to the optical axis to correct image shake caused by vibration.

An image-shake correction lens group of the rear lens group may include at least one lens having cut edge portions.

The rear lens group may satisfy the following condition,

0.6≦φ_{S}/φ_{L}≦0.9,

where φ_{S} is the shorter diameter of the lens having cut edge portions, and φ_{L} is the longer diameter of the lens having the cut edge portions.

The rear lens group may satisfy the following condition,

1.45≦f₁₃/f_{w}≦1.85,

where f₁₃ is a combined focal distance of the rear lens group, and f_{W} is a combined focal distance of the zoom lens system at a wide-angle position.

The rear lens group may comprise at least one aspherical surface.

The reflector of the zoom lens system may be formed of a prism.

The second lens group of the zoom lens system may comprise two lenses cemented as a doublet lens.

According to another embodiment of the present invention, a zoom lens system is provided that includes: a first lens group having positive refractive power; a second lens group having negative refractive power; a third lens group having positive refractive power; a fourth lens group having positive refractive power; and a fifth lens group having positive refractive power, wherein the first, second, third, fourth, and fifth lens groups are sequentially arranged from an object side to an image side along an optical axis, and during a magnification change the second lens group and the fourth lens group are moved toward each other along the optical axis, and the first lens group comprises a first lens having negative refractive power, a reflector bending the optical axis by 90°, and a rear lens group having at least one lens having positive refractive power and disposed after the reflector, and the whole rear lens group or a portion of the rear lens group is moved in a direction perpendicular to the optical axis to correct image shake caused by vibration.

The rear lens group may satisfy the following condition,

1.45≦f₁₃/f_{w}≦1.85,

where f₁₃ is a combined focal distance of the rear lens group, and f_{W} is a combined focal distance of the zoom lens system at a wide-angle position.

The rear lens group may include at least one aspherical surface.

The image-shake correction lens group of the rear lens group may comprise at least one lens having cut edge portions.

The rear lens group may satisfy the following condition,

0.6≦φ_{S}/φ_{L}≦0.9,

where φ_{S} is the shorter diameter of the lens having the cut edge portions, and φ_{L} is the longer diameter of the lens having the cut edge portions.

The reflector of the zoom lens system may be formed of a prism.

The second lens group of the zoom lens system may comprise two lenses cemented as a doublet lens.

The third lens group of the zoom lens system may be a single lens.

The third lens group of the zoom lens system may comprise an aperture stop.

The fifth lens group of the zoom lens system may be a single lens.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating examples of the cases of a zoom lens system at a wide angle position, an intermediate angle position and a telephoto position, according to an embodiment of the present invention;

FIG. 2 illustrates an example of a lens of a rear lens group included in the zoom lens system of FIG. 1;

FIGS. 3 through 5 illustrate examples of the spherical aberration, astigmatic field curvature, and distortion at a wide angle position, an intermediate angle position and a telephoto position of the zoom lens system of FIG. 1, respectively;

FIG. 6 is a cross-sectional view illustrating examples of the cases of a zoom lens system at a wide angle position, an intermediate angle position and a telephoto position, according to another embodiment of the present invention;

FIGS. 7 through 9 illustrate examples of the spherical aberration, astigmatic field curvature, and distortion at a wide angle position, an intermediate angle position and a telephoto position of the zoom lens system of FIG. 6, respectively;

FIG. 10 is a cross-sectional view illustrating examples of the cases of a zoom lens system at a wide angle position, an intermediate angle position and a telephoto position, according to another embodiment of the present invention; and

FIGS. 11 through 13 illustrate examples of the spherical aberration, astigmatic field curvature, and distortion at a wide angle position, an intermediate angle position and a telephoto position of the zoom lens system of FIG. 10, respectively.

### DETAILED DESCRIPTION OF THE INVENTION

Hereinafter, the present invention of a zoom lens system will be described more fully with regard to exemplary embodiments of the invention with reference to the attached drawings.

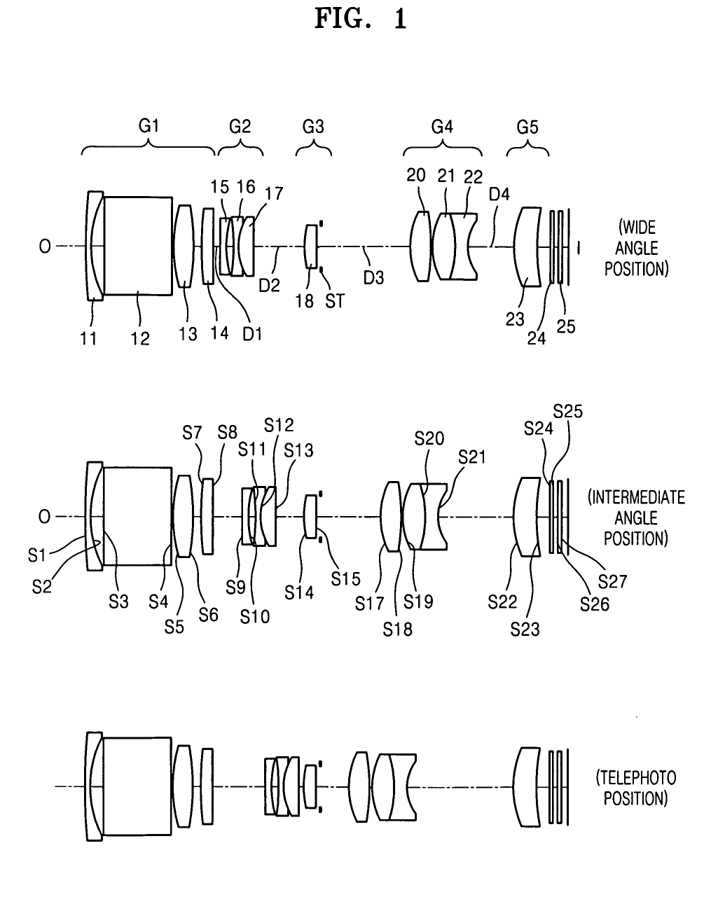

FIG. 1 is a cross-sectional view illustrating examples of the cases of a zoom lens system at a wide angle position, an intermediate angle position, and a telephoto position, according to an embodiment of the present invention. Referring to the examples of FIG. 1, the zoom lens system includes, sequentially from an object side “O” towards an image side “I”, a first lens group G1 having positive refractive power, a second lens group G2 having negative refractive power, and at least one lens group located on an image side of the second lens group G2. During a magnification change from a wide-angle position to a telephoto position, the lens groups including at least the second lens group G2 are moved with respect to an optical axis.

The first lens group G1 includes a first lens 11 having negative refractive power, a reflector 12 bending the optical axis by 90°, and a rear lens group having at least one lens having positive refractive power and disposed after the reflector 12. According to the present invention, the whole rear lens group or a portion thereof is moved in a direction perpendicular to the optical axis, thereby correcting image shake caused by vibration.

For example, as illustrated in FIG. 1, the zoom lens system according to the current embodiment of the present invention may include first through fifth lens groups G1, G2, G3, G4, and G5. The first lens group G1 includes the reflector 12, thereby reducing the whole thickness of the optical system to thus manufacture a very thin optical system. The whole rear lens group or a portion thereof, which is disposed after the reflector 12 of the first lens group G1, is operated as a correction lens group due to hand-shake. In detail, the first lens group G1 may include the first lens 11, the reflector 12, and a second lens 13 as a rear lens group for correcting image shake. The second lens 13 is disposed after the reflector 12 to correct image shake due to hand-shake by the user. Alternatively, the rear lens group may include the second lens 13 and a third lens 14 which may be used to correct image shake.

The second lens group G2 may include a fourth lens 15 having negative refractive power and a fifth lens 16 and a sixth lens 17 having negative refractive powers and configured as a doublet lens, sequentially formed from the object side “O”.

The third lens group G3 may include a seventh lens 18, and a stop disposed after the seventh lens 18. The fourth lens group G4 may include an eighth lens 20, a ninth lens 21, and a tenth lens 22, and the fifth lens group G5 may include an eleventh lens 23.

For example, during a magnification change from a wide-angle position to a telephoto position, the second lens group G2 and the fourth lens group G4 may be moved together toward each other; that is, the second lens group G2 may be moved toward the image side, and the fourth lens group G4 may be moved toward the object side “O”.

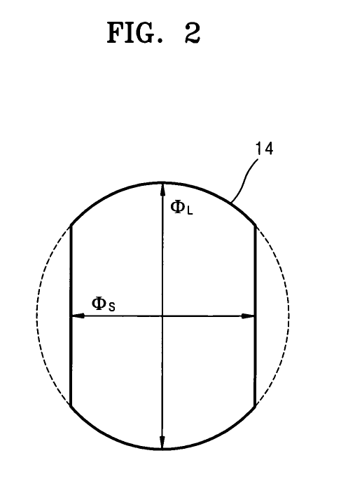

Meanwhile, when the zoom lens system according to the current embodiment of the present invention uses a solid state imaging device having an imaging surface having a rectangular shape with a 4:3 ratio, light rays that transmit through edge portions of a lens are not used as effective rays for forming an image. Also, the thickness of the zoom lens system is increased in order to provide a space in which the correction lens group for hand-shake correction can be moved. Considering these two points, the edge portions of the lens through which ineffective light rays transmit may be cut to reduce the thickness of the zoom lens system. FIG. 2 illustrates an example of a lens of a rear lens group included in the zoom lens system of FIG. 1. Thus, as illustrated in FIG. 2, the image-shake correction lens group of the rear lens group disposed after the reflector 12 in the first lens group G1 may include at least one lens having cut edge portions.

The following condition defines the cutting amount of the lens of the image-shake correction lens group, which has cut edge portions.

0.6≦φ_{S}/φ_{L}≦0.9 [Inequality 1]

In Inequality 1, φ_{S} is the shorter diameter of the lens having the cut edge portions, and φ_{L} is the longer diameter of the lens having the cut edge portions. When φ_{S}/φ_{L} exceeds the upper limit of Inequality 1, the cutting amount is short and thus a thin zoom lens system cannot be reached. On the contrary, when φ_{S}/φ_{L} exceeds the lower limit, the cutting amount is excessive and the amount of light in the peripheral portion of the zoom lens system is decreased, thus causing difficulty in realizing a good optical performance.

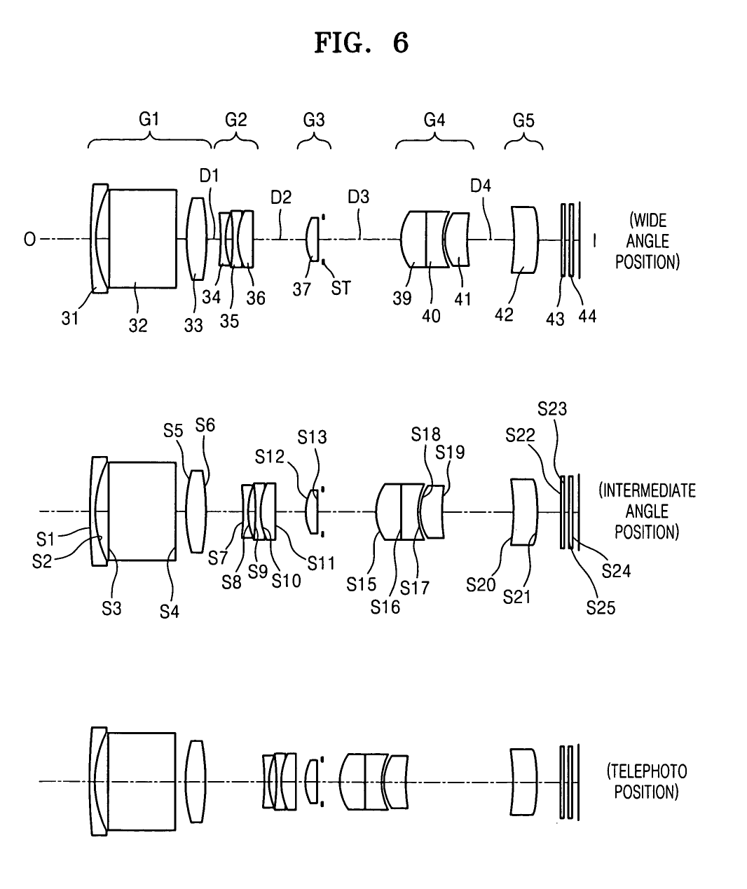

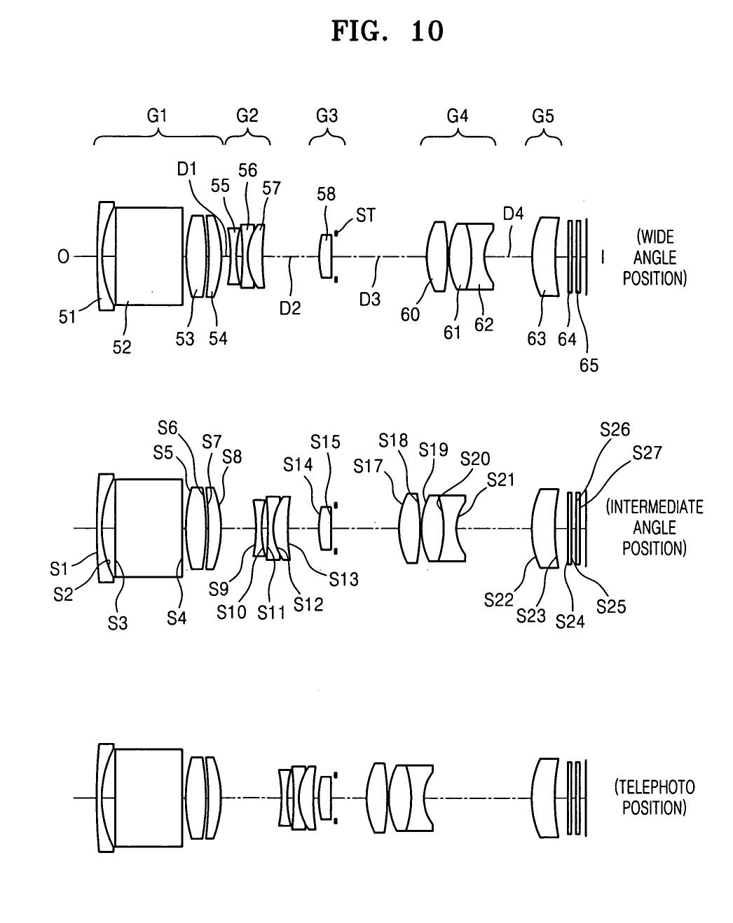

For example, in FIG. 1, edge portions of the third lens 14 may be cut, and φ_{S} may be 7.4, and φ_{L} may be 9.5. FIG. 6 is a cross-sectional view illustrating examples of the cases of a zoom lens system at a wide angle position, an intermediate angle position and a telephoto position, according to another embodiment of the present invention. In FIG. 6, a lens 33 is included after a reflector 32 as a correction lens group, and edge portions of the lens 33 may be cut such that φ_{S} may be 8.0 and φ_{L} may be 9.2. FIG. 10 is a cross-sectional view illustrating examples of the cases of a zoom lens system at a wide angle position, an intermediate angle position and a telephoto position, according to another embodiment of the present invention. In FIG. 10, two lenses 53 and 54 are included after a reflector 52 as a correction lens group, and edge portions of the lenses 53 and 54 may be cut such that φ_{S} may be 6.5 and φ_{L} may be 9.8.

The rear lens group of the zoom lens system, according to the embodiment of the present invention, satisfies the following Inequality 2.

1.45≦f₁₃/f_{w}≦1.85 [Inequality 2]

In Inequality 2, f₁₃ is a combined focal length of the rear lens group, and f_{W} is a combined focal length of the zoom lens system at the wide-angle position. Inequality 2 defines the ratio of the focal length of the rear lens group disposed after the reflector 12 of the first lens group G1 to the focal length of the entire zoom lens system. When f₁₃/f_{w} is outside the range of Inequality 2, it is difficult to provide good resolving power in the telephoto position, and moreover, the distance for the correction lens group to move is increased when a hand-shake occurs, and thus it becomes difficult to manufacture a thin zoom lens system.

Meanwhile, the rear lens group according to the current embodiment of the present invention includes at least one aspherical surface to reduce spherical aberration, astigmatism, and distortion.

According to the embodiment of FIG. 1, the first lens group G1 includes the single first lens 11 having negative refractive power, the reflector 12, and both the second and third lenses 13 and 14 having positive refractive powers, sequentially formed from the object side “O”. The third lens 14 of the two lenses of the rear lens group disposed after the reflector 12 corrects image shake. The reflector 12 may be a prism. The second lens group G2 includes the single lens 15 having negative refractive power and the fifth and sixth lenses 16 and 17 having negative refractive powers and configured as a doublet lens, sequentially formed from the object side “O”. The third lens group G3 includes the single seventh lens 18 having positive refractive power and the stop ST. The fourth lens group G4 includes the single eighth lens 20 and both the ninth and tenth lenses 21 and 22 configured as a doublet lens. The fifth lens group G5 includes the single eleventh lens 23 having positive refractive power. The second lens group G2 and the fourth lens group G4 are moved along the optical axis and change magnification. A hand-shake correction lens group is disposed after a prism of the first lens group G1, moving on a plane perpendicular to the optical axis and thereby correcting image shake. Accordingly, a good image can be obtained. The zoom lens system further includes filters 24 and 25.

According to the embodiment illustrated in FIG. 6, the first lens group G1 includes a single lens 31 having negative refractive power, the reflector 32, and the lens 33 having positive refractive power, sequentially formed from an object side “O”. The lens 33, disposed after the reflector 32, corrects image shake. The second lens group G2 includes a single lens 34 having negative refractive power and two lenses 35 and 36 configured as a doublet lens, sequentially formed from the object side “O”. The third lens group G3 includes a single lens 37 having positive refractive power and a stop ST. The fourth lens group G4 includes two lenses 39 and 40 configured as a doublet lens and a single lens 41. The fifth lens group G5 includes a single lens 42 having positive refractive power. The second lens group G2 and the fourth lens group G4 are moved along the optical axis and change magnification. The zoom lens system further includes filters 43 and 44.

According to the embodiment illustrated in FIG. 10, the first lens group G1 includes a single lens 51 having negative refractive power, a reflector 52, and two lenses 53 and 54 having positive refractive powers, sequentially formed from an object side “O”. The two lenses 53 and 54, which are disposed after the reflector 52, correct image shake. The second lens group G2 includes a single lens 55 having negative refractive power and two lenses 56 and 57 having negative refractive powers and configured as a doublet lens, sequentially formed from an object side “O”. The third lens group G3 includes a single lens 58 having positive refractive power and a stop ST. The fourth lens group G4 includes a single lens 60 and two lenses 61 and 62 configured as a doublet lens. The fifth lens group G5 includes a single lens 63 having positive refractive power. The zoom lens system further includes filters 64 and 65.

Meanwhile, an aspherical surface in the embodiments of the present invention is defined as follows.

Assuming that an optical axis direction is an X axis direction, a direction perpendicular to the optical axis direction is a Y axis direction, and the direction in which a light ray proceeds is positive, the shape of the aspherical surface of the zoom lens according to the each of the embodiments of the present invention can be expressed by the following equation, where x is the distance from the apex of a lens in the optical direction, h is the distance in the direction perpendicular to the optical axis, K is a conic constant, A, B, C, and D are aspherical coefficients, and c is a reciprocal number (1/R) of the radius of curvature at the apex of a lens.

$$x = \frac{{cy}^{2}}{1 + \sqrt{1 - ( K + 1 ) {c}^{2} {h}^{2}}} + A {h}^{4} + {Bh}^{6} + {Ch}^{8} + {Dh}^{10} \qquad [ Equation 3 ]$$

The present invention includes lenses in optimal conditions to embody the miniaturization of a zoom lens according to embodiments through the following various designs.

In the following description, f is a combined focal length of the overall zoom lens system, Fno is an F number, 2ω is a viewing angle, R is a radius of curvature, Dn is a thickness of the center of a lens or an interval between lenses, nd is a refractive index of a material of a lens, and vd is an Abbe number. Also, ST is an aperture stop, D1, D2, D3 and D4 are variable distances, and ASP is an aspherical surface.

### Embodiment 1

FIG. 1 is a cross-sectional view illustrating examples of the cases of a zoom lens system at a wide angle position, an intermediate angle position, and a telephoto position, respectively, according to an embodiment of the present invention. The zoom lens system includes first, second, third, fourth, and fifth lens groups G1, G2, G3, G4, and G5.

f; 6.80~11.07~19.38 Fno; 3.65~4.28~5.19 2ω; 57.7~35.6~20.64

| Lens surface | R | Dn | nd | vd |
|---|---|---|---|---|
| S1 | 87.925 | 0.60 | 1.83620 | 33.93 |
| S2 | 12.018 | 1.34 | | |
| S3 | infinity | 6.900 | 1.78590 | 43.93 |
| S4 | infinity | 0.24 | | |
| S5* | 13.749 | 2.10 | 1.58929 | 64.57 |

| | | |
|---|---|---|
| ASP: | | |
| K: −11.005192 | | |
| A: 0.389636E−03 | B: −0.125252E−04 | C: 0.666612E−06 |
| D: −0.212302E−07 | | |

| | | |
|---|---|---|
| S6* | −19.002 | 0.70 |

| | | |
|---|---|---|
| ASP: | | |
| K: −39.304757 | | |
| A: −0.748256E−03 | B: 0.297264E−04 | C: −0.657608E−06 |
| D: −0.141206E−08 | | |

| | | | | |
|---|---|---|---|---|
| S7 | 36.080 | 1.30 | 1.64266 | 60.68 |
| S8 | −114.395 | D1 | | |
| S9 | −25.432 | 0.50 | 1.81250 | 40.26 |
| S10 | 6.909 | 0.82 | | |
| S11 | −11.365 | 0.50 | 1.57390 | 65.27 |
| S12 | 6.700 | 1.47 | 1.84239 | 27.01 |
| S13 | 113.394 | D2 | | |
| S14* | 11.974 | 1.290 | 1.48749 | 70.44 |

| | | |
|---|---|---|
| ASP: | | |
| K: 7.366767 | | |
| A: −0.756978E−03 | B: −0.228437E−04 | C: 0.127493E−05 |
| D: −0.295672E−06 | | |

| | | | | |
|---|---|---|---|---|
| S15 | −22.110 | 0.40 | | |
| ST | infinity | D3 | | |
| S17 | 7.847 | 2.15 | 1.48749 | 70.44 |
| S18* | −13.948 | 0.20 | | |

| | | |
|---|---|---|
| ASP: | | |
| K: −2.233677 | | |
| A: 0.226243E−03 | B: −0.872952E−06 | C: 0.167996E−07 |
| D: −0.182312E−08 | | |

| | | | | |
|---|---|---|---|---|
| S19 | 6.950 | 2.16 | 1.52901 | 67.65 |
| S20 | −11.764 | 1.49 | 1.83800 | 31.60 |
| S21 | 4.865 | D4 | | |
| S22* | 9.277 | 2.50 | 1.60710 | 26.63 |

| | | |
|---|---|---|
| ASP: | | |
| K: −20.000000 | | |
| A: 0.295517E−02 | B: −0.194417E−03 | C: 0.934414E−05 |
| D: −0.182499E−06 | | |

| | | | | |
|---|---|---|---|---|
| S23 | 33.000 | 1.23 | | |
| S24 | infinity | 0.30 | 1.51680 | 64.20 |
| S25 | infinity | 0.30 | | |
| S26 | infinity | 0.50 | 1.51680 | 64.20 |
| S27 | infinity | 0.60 | | |

Table 1 shows variable distances D1, D2, D3, and D4 at a wide angle position, an intermediate angle position, and a telephoto position of the zoom lens system of FIG. 1.

TABLE 1

| Variable | Wide angle | Intermediate angle | Telephoto |
|---|---|---|---|
| distances | position | position | position |
| D1 | 0.700 | 3.071 | 5.443 |
| D2 | 5.243 | 2.872 | 0.500 |
| D3 | 9.167 | 6.279 | 3.032 |
| D4 | 4.647 | 7.533 | 10.780 |

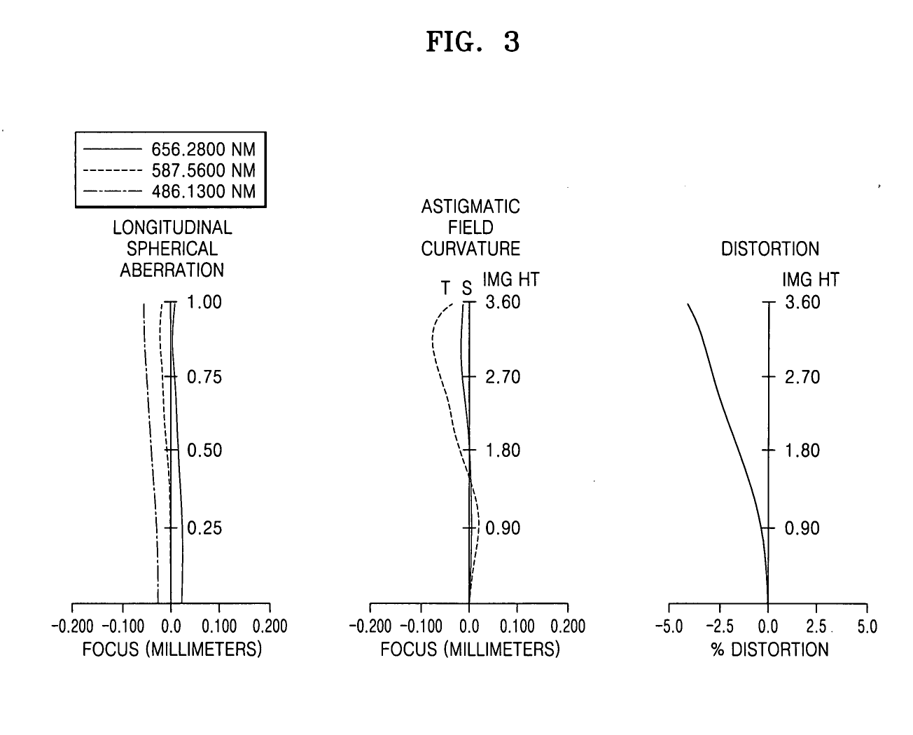

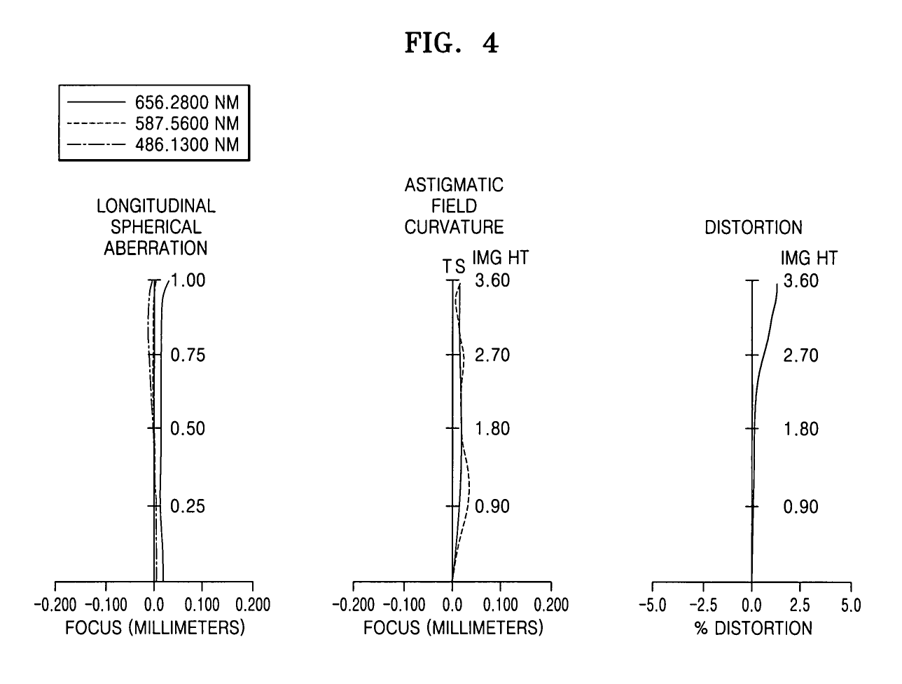

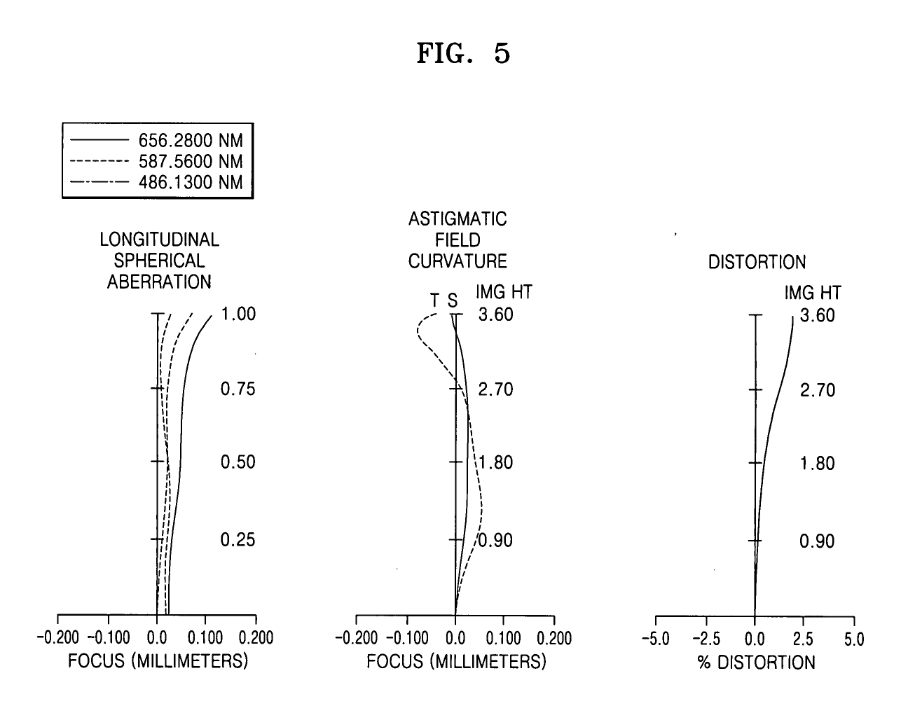

FIGS. 3 through 5 illustrate examples of the spherical aberration, astigmatic field curvature, and distortion at a wide angle position, an intermediate angle position and a telephoto position of the zoom lens system of FIG. 1, respectively. The astigmatic field curvature includes tangential astigmatic field curvature T and sagittal astigmatic field curvature S.

### Embodiment 2

FIG. 6 is a cross-sectional view illustrating examples of the cases of a zoom lens system at a wide angle position, an intermediate angle position and a telephoto position, respectively, according to another embodiment of the present invention. The zoom lens system includes first, second, third, fourth, and fifth lens groups G1, G2, G3, G4, and G5.

f; 6.45~10.00~18.06 Fno; 3.64~4.10~5.11 2ω; 60.40~39.11~22.12

| Lens surface | R | Dn | nd | vd |
|---|---|---|---|---|
| S1 | 83.038 | 0.61 | 1.92286 | 20.88 |
| S2 | 12.721 | 1.51 | | |
| S3 | infinity | 6.90 | 1.83400 | 37.34 |
| S4 | infinity | 0.80 | | |
| S5* | 12.875 | 2.10 | 1.75038 | 46.14 |

| | | |
|---|---|---|
| ASP: | | |
| K: −1.349540 | | |
| A: −0.439556E−04 | B: 0.303800E−05 | C: −0.320897E−07 |
| D: −0.174277E−08 | | |

| | | |
|---|---|---|
| S6* | −20.507 | D1 |

| | | |
|---|---|---|
| ASP: | | |
| K: −0.336566 | | |
| A: −0.264654E−04 | B: 0.576154E−05 | C: −0.184655E−06 |
| D: 0.109276E−08 | | |

| | | | | |
|---|---|---|---|---|
| S7 | −59.629 | 0.50 | 1.78913 | 44.22 |
| S8 | 6.926 | 0.75 | | |
| S9 | −14.886 | 0.50 | 1.68924 | 56.56 |
| S10 | 6.512 | 1.45 | 1.84666 | 23.78 |
| S11 | 37.065 | D2 | | |
| S12* | 9.737 | 1.23 | 1.68826 | 47.37 |

| | | |
|---|---|---|
| ASP: | | |
| K: 0.205673 | | |
| A: −0.213700E−03 | B: 0.128296E−05 | C: 0.478483E−06 |
| D: −0.755084E−07 | | |

| | | | | |
|---|---|---|---|---|
| S13 | 71.720 | 0.50 | | |
| ST | infinity | D3 | | |
| S15 | 6.519 | 2.50 | 1.68726 | 56.73 |
| S16 | −62.026 | 1.79 | 1.84666 | 23.78 |
| S17 | 7.154 | 0.30 | | |
| S18 | 6.292 | 2.10 | 1.57619 | 57.17 |
| S19* | 22.214 | D4 | | |

| | | |
|---|---|---|
| ASP: | | |
| K: −2.470642 | | |
| A: 0.180407E−02 | B: 0.492081E−04 | C: −0.923159E−06 |
| D: 0.162670E−06 | | |

| | | | | |
|---|---|---|---|---|
| S20* | −164.949 | 2.50 | 1.53120 | 56.51 |

| | | |
|---|---|---|
| ASP: | | |
| K: 433.302733 | | |
| A: −0.629019E−03 | B: 0.605641E−04 | C: −0.394423E−05 |
| D: 0.416663E−07 | | |

| | | |
|---|---|---|
| S21* | −27.832 | 22.11 |

| | | |
|---|---|---|
| ASP: | | |
| K: 25.385077 | | |
| A: −0.719094E−03 | B: 0.819356E−04 | C: −0.334042E−05 |
| D: 0.702647E−08 | | |

| | | | | |
|---|---|---|---|---|
| S22 | infinity | 0.55 | 1.51680 | 64.20 |
| S23 | infinity | 0.50 | | |
| S24 | infinity | 0.50 | 1.51680 | 64.20 |
| S25 | infinity | 0.60 | | |

Table 2 shows variable distances D1, D2, D3, and D4 at a wide angle position, an intermediate angle position, and a telephoto position of the zoom lens system of FIG. 6.

TABLE 2

| Variable | Wide angle | Intermediate angle | Telephoto |
|---|---|---|---|
| distances | position | position | position |
| D1 | 1.40 | 3.73 | 6.06 |
| D2 | 5.66 | 3.34 | 1.00 |
| D3 | 7.98 | 5.61 | 2.00 |
| D4 | 4.74 | 7.11 | 10.72 |

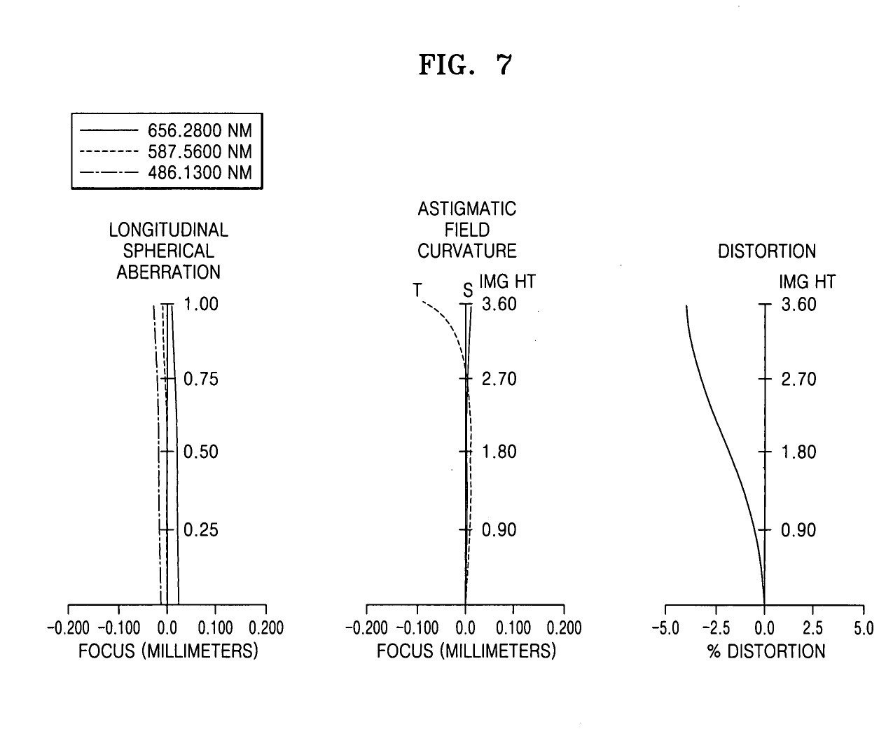

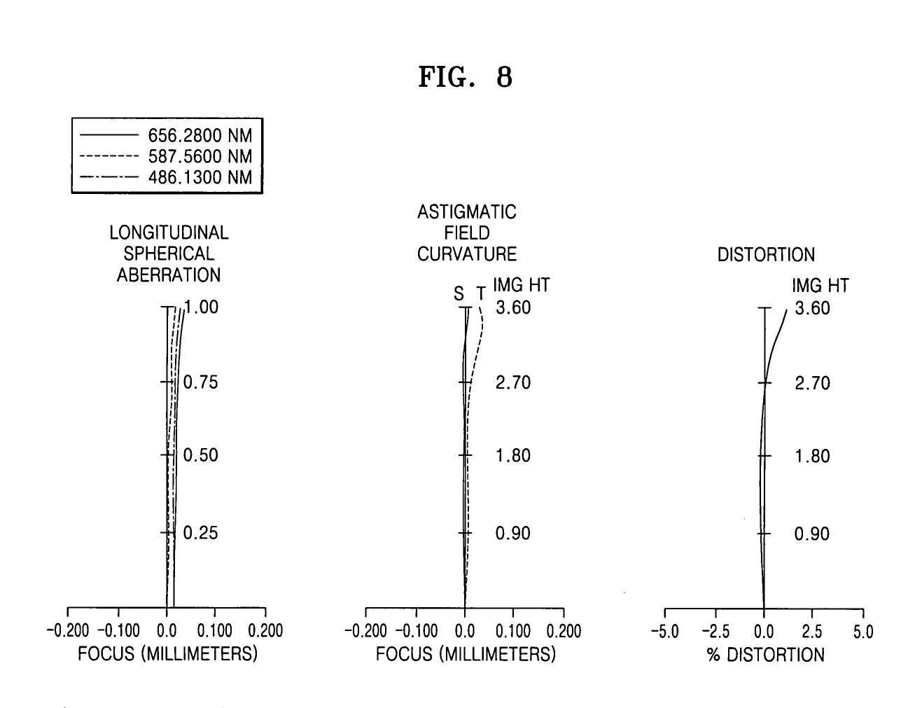

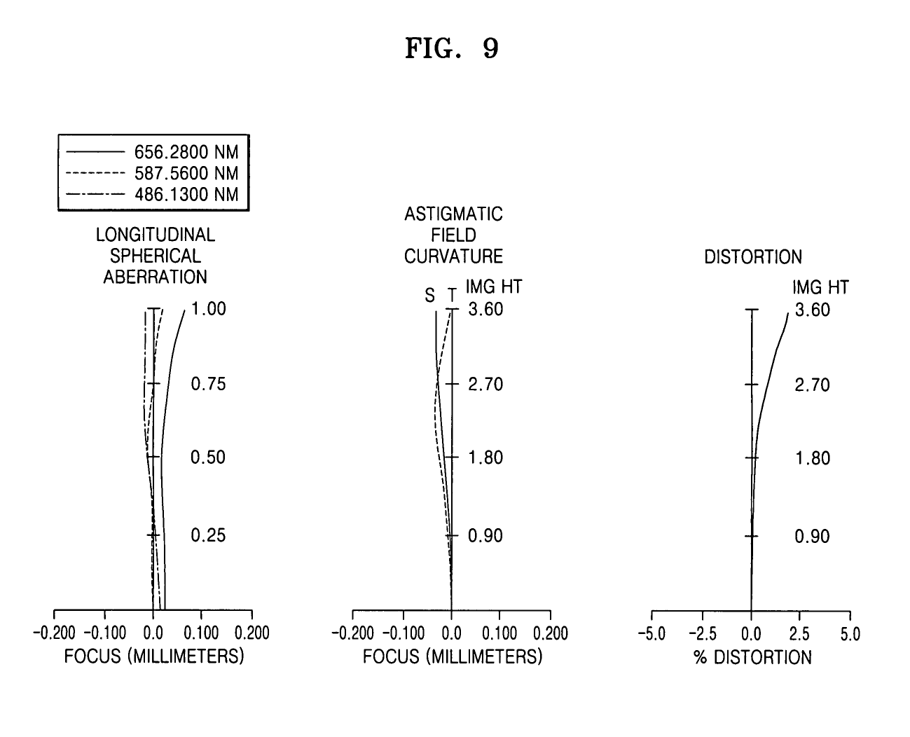

FIGS. 7 through 9 illustrate examples of the spherical aberration, astigmatic field curvature, and distortion at a wide angle position, an intermediate angle position and a telephoto position of the zoom lens system of FIG. 6, respectively.

### Embodiment 3

FIG. 10 is a cross-sectional view illustrating examples of the cases of a zoom lens system at a wide angle position, an intermediate angle position and a telephoto position, respectively, according to another embodiment of the present invention. The zoom lens system includes first, second, third, fourth, and fifth lens groups G1, G2, G3, G4 and G5.

f; 6.81~11.05~19.38 Fno; 3.64~4.25~5.13 2ω; 57.72~35.42~20.64

| Lens surface | R | Dn | nd | vd |
|---|---|---|---|---|
| S1 | 144.925 | 0.60 | 1.83725 | 32.53 |
| S2 | 13.574 | 1.24 | | |
| S3 | infinity | 6.90 | 1.78590 | 43.93 |
| S4 | infinity | 0.50 | | |
| S5* | 14.884 | 2.08 | 1.58216 | 64.89 |

| | | |
|---|---|---|
| ASP: | | |
| K: −9.997772 | | |
| A: 0.296268E−03 | B: −.147322E−04 | C: 0.751986E−06 |
| D: −.255007E−07 | | |

| | | |
|---|---|---|
| S6* | −17.422 | 0.10 |

| | | |
|---|---|---|
| ASP: | | |
| K: −36.438841 | | |
| A: −.738390E−03 | B: 0.282995E−04 | C: −.649281E−06 |
| D: −.343621E−08 | | |

| | | | | |
|---|---|---|---|---|
| S7 | −32.147 | 1.21 | 1.70410 | 55.48 |
| S8 | −17.746 | D1 | | |
| S9 | −18.865 | 0.50 | 1.75306 | 52.43 |
| S10 | 7.692 | 0.75 | | |
| S11 | −21.077 | 0.50 | 1.56329 | 65.78 |
| S12 | 5.853 | 1.55 | 1.83749 | 32.22 |
| S13 | 28.008 | D2 | | |
| S14* | 11.251 | 1.29 | 1.48749 | 70.44 |

| | | |
|---|---|---|
| ASP: | | |
| K: 6.713412 | | |
| A: −.793086E−03 | B: −.316810E−04 | C: 0.199084E−05 |
| D: −.351341E−06 | | |

| | | | | |
|---|---|---|---|---|
| S15 | −35.584 | 0.44 | | |
| ST | infinity | D3 | | |
| S17 | 7.462 | 2.50 | 1.48749 | 70.44 |
| S18* | −15.113 | 0.20 | | |

| | | |
|---|---|---|
| ASP: | | |
| K: −3.692235 | | |
| A: 0.276762E−03 | B: 0.228861E−05 | C: −.126114E−06 |
| D: 0.124323E−08 | | |

| | | | | |
|---|---|---|---|---|
| S19 | 6.829 | 2.04 | 1.54871 | 66.53 |
| S20 | −15.302 | 1.20 | 1.82137 | 31.14 |
| S21 | 4.488 | D4 | | |
| S22* | 9.000 | 2.50 | 1.60710 | 26.63 |

| | | |
|---|---|---|
| ASP: | | |
| K: −13.600741 | | |
| A: 0.229859E−02 | B: −.104891E−03 | C: 0.416375E−05 |
| D: −.679363E−07 | | |

| | | | | |
|---|---|---|---|---|
| S23 | 30.412 | 1.39 | | |
| S24 | infinity | 0.30 | 1.51680 | 64.20 |
| S25 | infinity | 0.50 | | |
| S26 | infinity | 0.50 | 1.51680 | 64.20 |
| S27 | infinity | 0.60 | | |

Table 3 shows variable distances D1, D2, D3, and D4 at a wide angle position, an intermediate angle position, and a telephoto position of the zoom lens system of FIG. 10.

TABLE 3

| Variable | Wide angle | Intermediate angle | Telephoto |
|---|---|---|---|
| distances | position | position | position |
| D1 | 1.00 | 3.66 | 6.33 |
| D2 | 5.83 | 3.17 | 0.50 |
| D3 | 9.16 | 6.33 | 3.09 |
| D4 | 4.92 | 7.75 | 10.99 |

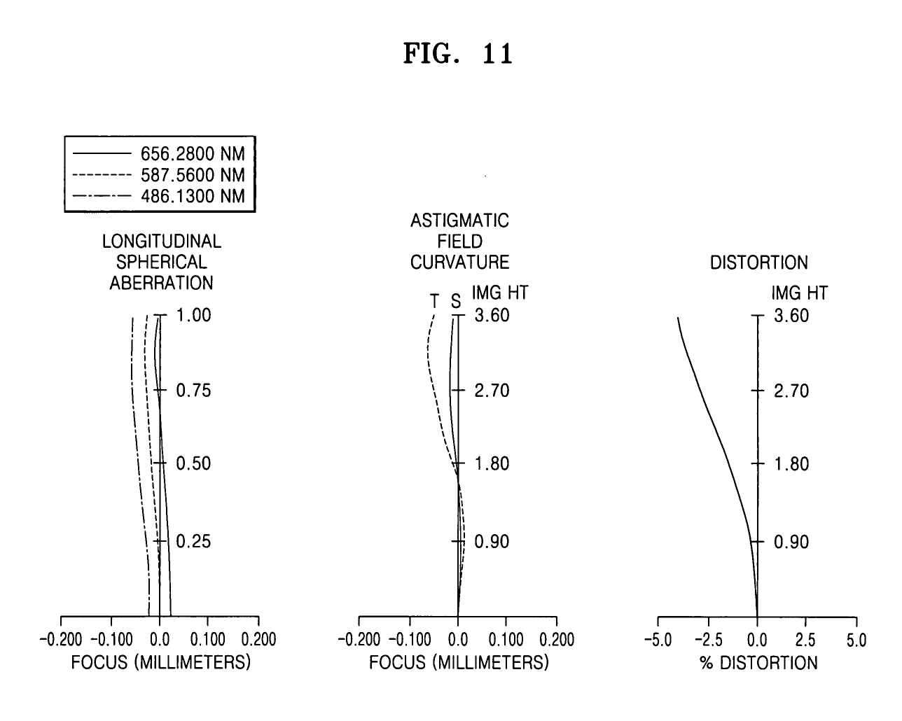

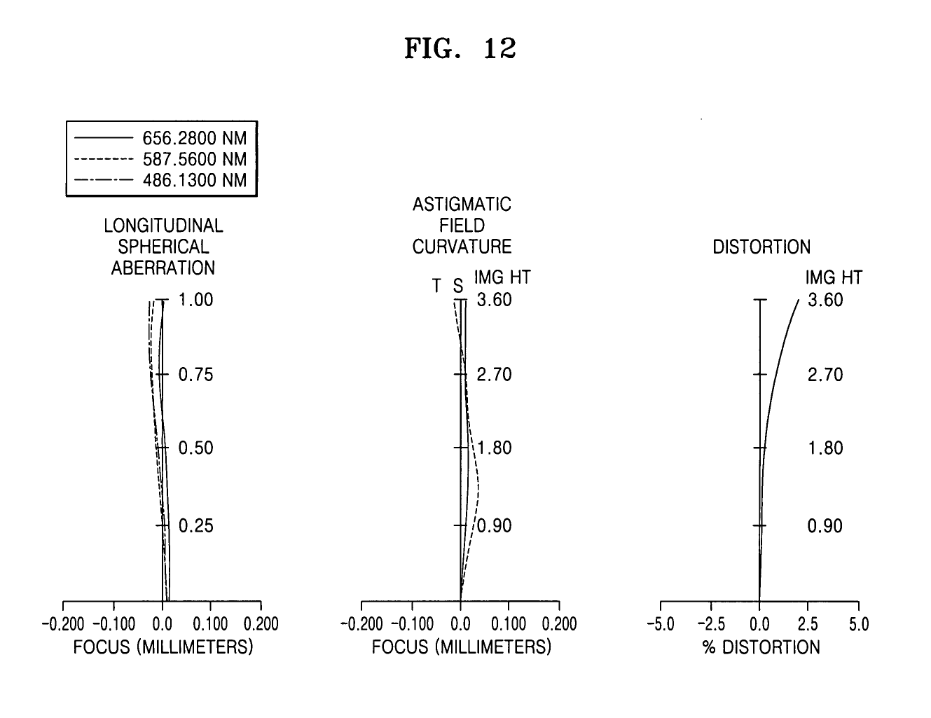

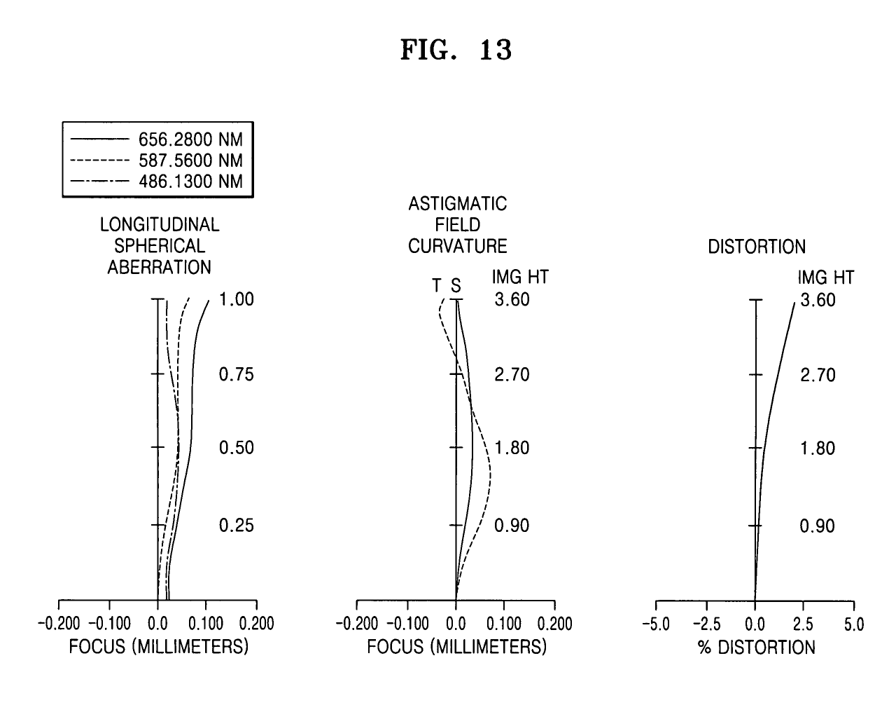

FIGS. 11 through 13 illustrate examples of the spherical aberration, astigmatic field curvature, and distortion at a wide angle position, an intermediate angle position and a telephoto position of the zoom lens system of FIG. 10, respectively.

Table 4 shows that the above embodiments satisfy the conditions of the above Inequalities 1 and 2.

TABLE 4

| | Embodiment 1 | Embodiment 2 | Embodiment 3 |
|---|---|---|---|
| Inequality 1 | 0.78 | 0.87 | 0.66 |
| Inequality 2 | 1.59 | 1.66 | 1.70 |

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A zoom lens system comprising:
a first lens group having positive refractive power;
a second lens group having negative refractive power; and
at least one lens group disposed between the second lens group and an image side,
wherein the first, second, and the at least one lens group are sequentially arranged from an object side to the image side,
during a magnification change from a wide-angle position to a telephoto position, lens groups including at least the second lens group are moved with respect to an optical axis, and
the first lens group comprises a first lens having negative refractive power, a reflector bending the optical axis by 90°, and a rear lens group comprising at least one lens having positive refractive power and disposed after the reflector, and
the whole rear lens group or a portion of the rear lens group is moved in a direction perpendicular to the optical axis to correct image shake caused by vibration.

2. The zoom lens system of claim 1, wherein an image-shake correction lens group of the rear lens group comprises at least one lens having cut edge portions.

3. The zoom lens system of claim 2, wherein the rear lens group satisfies the following condition,
0.6≦φ_{S}/φ_{L}≦0.9,
where φ_{S} is the shorter diameter of the lens having cut edge portions, and φ_{L} is the longer diameter of the lens having the cut edge portions.

4. The zoom lens system of claim 1, wherein the rear lens group satisfies the following condition,
1.45≦f₁₃/f_{w}≦1.85,
where f₁₃ is a combined focal distance of the rear lens group, and f_{W} is a combined focal distance of the zoom lens system at a wide-angle position.

5. The zoom lens system of claim 1, wherein the rear lens group comprises at least one aspherical surface.

6. The zoom lens system of claim 1, wherein the reflector is formed of a prism.

7. The zoom lens system of claim 1, wherein the second lens group comprises two lenses cemented as a doublet lens.

8. A zoom lens system comprising:
a first lens group having positive refractive power;
a second lens group having negative refractive power;
a third lens group having positive refractive power;
a fourth lens group having positive refractive power; and
a fifth lens group having positive refractive power,
wherein the first, second, third, fourth, and fifth lens groups are sequentially arranged from an object side to an image side along an optical axis, and
during a magnification change the second lens group and the fourth lens group are moved toward each other along the optical axis, and
the first lens group comprises a first lens having negative refractive power, a reflector bending the optical axis by 90°, and a rear lens group having at least one lens having positive refractive power and disposed after the reflector, and
the whole rear lens group or a portion of the rear lens group is moved in a direction perpendicular to the optical axis to correct image shake caused by vibration.

9. The zoom lens system of claim 8, wherein an image-shake correction lens group of the rear lens group comprises at least one lens having cut edge portions.

10. The zoom lens system of claim 9, wherein the rear lens group satisfies the following condition,
0.6≦φ_{S}/φ_{L}≦0.9,
where φ_{S} is the shorter diameter of the lens having the cut edge portions, and φ_{L} is the longer diameter of the lens having the cut edge portions.

11. The zoom lens system of claim 8, wherein the rear lens group satisfies the following condition,
1.45≦f₁₃/f_{w}≦1.85,
where f₁₃ is a combined focal distance of the rear lens group, and f_{W} is a combined focal distance of the zoom lens system at a wide-angle position.

12. The zoom lens system of claim 8, wherein the rear lens group comprises at least one aspherical surface.

13. The zoom lens system of claim 8, wherein the reflector is formed of a prism.

14. The zoom lens system of claim 8, wherein the second lens group comprises two lenses cemented as a doublet lens.

15. The zoom lens system of claim 8, wherein the third lens group is a single lens.

16. The zoom lens system of claim 15, wherein the third lens group comprises an aperture stop.

17. The zoom lens system of claim 8, wherein the fifth lens group is a single lens.
